(19) United States
(12) Patent Application Publication
(10) Pub. No.: US 2008/0270641 A1
(43) Pub. Date: Oct. 30, 2008

(54) Digital sending device preconfigured to use vendor-provided computer network resources to deliver electronic content

(76) Inventors: Rick R. Rothwell, Boise, ID (US); Steven G. Henry, Fort Collins, CO (US); D. Richard Young, Kuna, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,227

(22) Filed: Apr. 30, 2007

(51) Int. Cl. G06F 13/00

(52) U.S. Cl. 710/33

(57) ABSTRACT

A digital sending device peripheral to a computer network includes a user interface to accept a physical content, a digitizer coupled to the user interface to convert the physical content into an electronic content and a transmitter coupled to the user interface and to the digitizer and preconfigured to deliver the electronic content through a vendor-provided computer network resource to a computer network destination.

### BACKGROUND

Many small and medium businesses rely on Internet Service Providers (ISP) for Internet connectivity and do not want to invest in other computer network services like email servers, authentication servers, facsimile servers, etc. In addition, even if these network services are available, a user must know network parameters in order to configure a device to a computer network. In order to configure an email device to a computer network for example, a user must discover an email server and then know how to configure the email device to the server. Email servers require very specific settings such as an IP address, network port, and user credentials which change over time. This creates a training burden on limited staff that are often not prepared to deal with such technical hurdles.

Existing solutions have typically relied upon a user's IT department or ISP support for computer network information and settings. Additionally, firewalls and security infrastructure have made configuration more difficult. Even when configured correctly, many customer environments rely on a fairly simple network infrastructure and do not therefore provide redundant servers and services on a computer network. This results in lower reliability and a single point of failure. Since a customer's or an ISP's infrastructure changes over time, services may fail until reconfigured.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a system block diagram showing how an embodiment relates to its environment;

FIG. 2 is a system block diagram of another embodiment showing additional details of the system of FIG. 1;

FIG. 3 is a block diagram of a digital sending device in accordance with an embodiment;

FIG. 4 is a flow chart of a method of digitally sending a physical content to a computer network destination in accordance with an embodiment;

FIG. 5 is a flow chart of a method of preconfiguring a digital sending device for a first and second vendor provided computer network resource in accordance with an embodiment; and

FIG. 6 is a flow chart of a method in accordance with an embodiment adding steps to the flow chart of FIG. 4.

### DETAILED DESCRIPTION OF EXAMPLE EMBODIMENTS

In describing embodiments of the present invention, the following terminology will be used.

The singular forms “a,” “an,” and “the” include plural referents unless the context clearly dictates otherwise. Thus, for example, reference to “a device” includes reference to one or more of such devices.

Reference will now be made to the exemplary embodiments illustrated, and specific language will be used herein to describe the same. It will nevertheless be understood that no limitation of the scope of the invention is thereby intended.

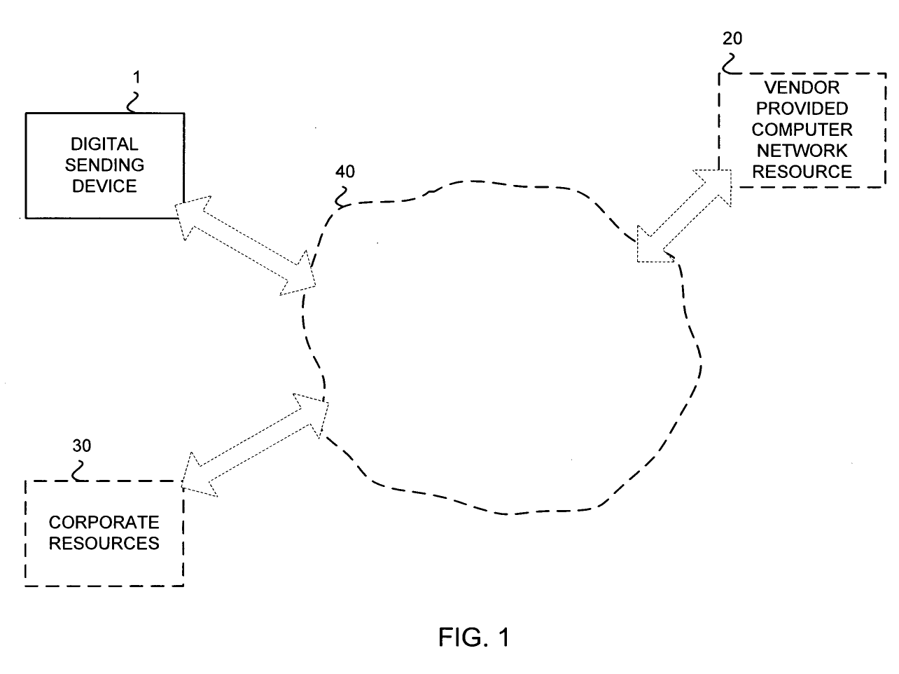

FIG. 1 is a system block diagram showing how an embodiment relates to its environment. A digital sending device (DSD) 1, such as a printer, scanner, or facsimile device and the like, is coupled to a computer network 40 and is preconfigured to use a vendor-provided computer network resource (VPCNR) 20. For example, the VPCNR can be a digital sending service for delivering electronic content through the computer network 40. Preconfigured network parameters may include server and client Internet Protocol (IP) addresses, network ports, user credentials and privileges, and device driver names to enable the digital sending device to access the digital sending service. Furthermore, different file systems require different security parameters and printer protocols that may also be preconfigured for the VPCNR.

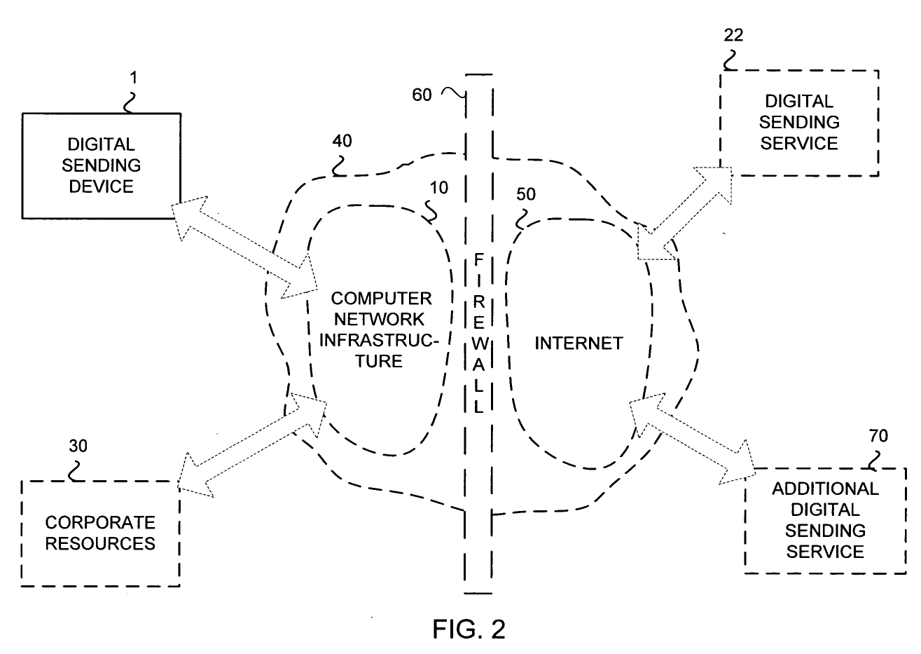

For example, as illustrated in FIG. 2, the VPCNR can be a digital sending service 22, that may include software residing on a vendor provided host for network authentication, the ability to send to corporate resources 30 including personal computers, workstations, facsimile services, shared network folders, directories, printers, and File Transfer Protocol (FTP) sites, and the ability to send from a DSD 1 to corporate resources 30 via an encrypted channel. Digital sending services 22 may include software to allow workgroups to easily capture documents, extract relevant data, index the documents, and distribute them to multiple destinations including fax, email, shared network folders, directories, and content management systems. Also a digital sending service 22 may include software residing on a vendor provided host for generating higher quality images through deskew, despeckle, text smoothing, and removal of dots, lines, borders, etc. to convert docs into Portable Document Format (PDF).

Various arrangements of the computer network 40 used to access the digital sending services may be used. For example, the computer network 40 may comprise a computer network infrastructure 10, such as a corporate local area network (LAN) and the Internet 50 separated by a firewall 60. Portions of the computer network infrastructure may also be provided by the vendor.

Depending on the size of the customer's business and digital sending needs a business may have very little to no computer network infrastructure 10 and rely primarily or wholly on the Internet 50 for connectivity to the digital sending service 22. A computer network infrastructure 10 may include connectivity between computers and computer peripherals such as DSD 1 and peripherals combining scanners, printers, and facsimile devices also known as Multi-Function Products (MFP). A computer network infrastructure 10 may be any set of computers and devices connected to each other for example, through a corporate local area network, the Internet, or the like.

A preconfigured DSD 1 may be ready to use as soon as it is powered on and connected to a computer network 40. When powered on, the DSD may attempt to communicate with a number of VPCNRs. Configuration options are either preconfigured in the DSD or may be written to the DSD by the VPCNR without the need for configuration input from the user. That is, the VPCNR may include additional configuration information and network parameters to be delivered to the DSD that may change over time to adapt to changing network topologies, server address locations, etc. However, the user may be asked to enter an email address or some other piece of identifying information at the device. An email may automatically be sent to the user with a Uniform Resource Locator (URL) and additional information on a specific digital sending feature, and information on how to use and configure optional digital sending features. When the URL is selected, browser code may be executed to automatically establish a network link between a user's PC and the digital sending device. Users may then scan documents to their desktop.

As shown in FIG. 2 additional VPCNRs, such as an additional digital sending service 70 can also be provided. The DSD may select a ‘closest’ available digital sending service 22 and computer network infrastructure 10 and a second digital sending service 70 and second computer network infrastructure of the same type providing an extra measure of uptime assurance.

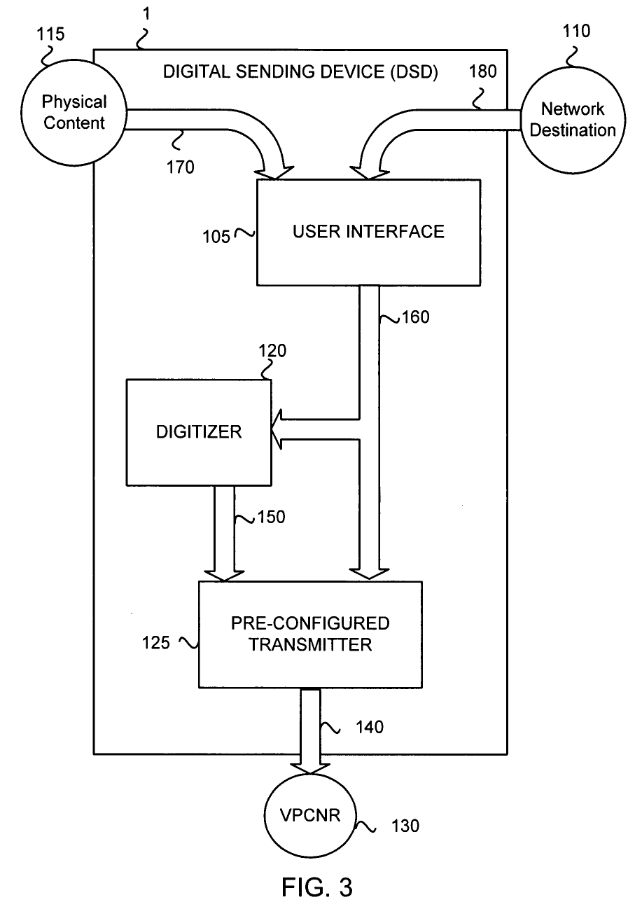

FIG. 3 is a block diagram of a DSD peripheral to a computer network 10 and a user in accordance with an embodiment. The DSD 1 includes a user interface 105 to accept a computer network destination 110 and a physical content 115 from the user. Also a digital sending service 22 may provide a computer network destination in addition to or in place of the user provided destination. Coupled to the user interface is a digitizer 120 to convert the physical content 110 into an electronic content. Also a transmitter 125 is coupled to the user interface and the digitizer and is preconfigured to use a VPCNR 130 to deliver the electronic content from the digitizer to the network destination provided by the user interface. A DSD may accept a physical content from a user and convert it to a standard digital format such as PDF. The DSD may send the digital content to either email or directly to a client desktop across a computer network infrastructure 10 using a digital sending service 22. The transmitter communicates with the VPCNR through a computer network 40 via a communication link 140. The digitizer communicates with the transmitter via a communication link 150. The user-interface communicates with the transmitter and the digitizer via a communication link 160. The channels 170 and 180 provide a physical content and a computer network destination respectively to the user interface.

DSD 1 includes devices such as input/output terminals, scanners, printers, facsimile devices. Computers and Personal Digital Assistants (PDA) that have access to a computer network 40 are also included. A user may therefore record his or her own audio onto a DSD and convert it into MP3 format for sending across the network for instance. Such a DSD may be preconfigured to deliver the electronic content via an encrypted channel to email and to FTP sites through a digital sending service 22.

The digitizer 120 may accept keyboard input as physical content from a user and convert it into electronic content for transmission across a computer network 40 using preconfigured parameters of a VPCNR. Also a digitizer may accept multimedia audiovisual physical content from a user for conversion into electronic content. Still photograph slide shows accompanied by music may be converted into electronic content by such a digitizer for encrypted delivery across a private computer network for instance. Also the DSD may have a digital token with an expiry for the token after a predetermined number of transactions. Such an expiry would require periodic update through a vendor for continued use of the digital sending service 22.

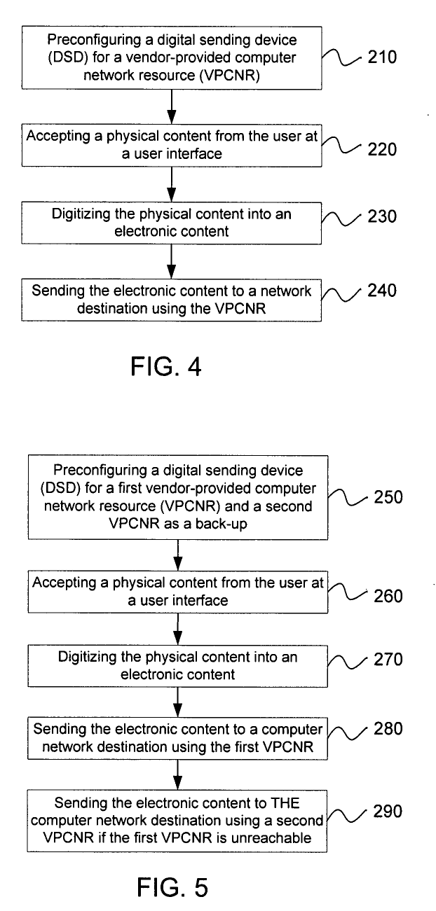

FIG. 4 is a flow chart of a method of digitally sending a physical content to a computer network destination in accordance with an embodiment. The DSD is preconfigured 210 for a VPCNR. The DSD accepts 220 a physical content from a user at a user interface. The device digitizes 230 the physical content into electronic content and the DSD sends 240 the electronic content using the VPCNR to a network destination. Also a VPCNR may provide a computer network destination in addition to or in place of the user provided computer network destination.

FIG. 5 is a flow chart of a method in accordance with an embodiment. The method further includes the step of preconfiguring 250 the DSD for a first VPCNR and also a second VPCNR as a backup. The DSD accepts 260 a physical content from a user at a user interface. The DSD digitizes 270 the physical content into electronic content and sends 280 the electronic content using the VPCNR to the computer network destination. If the first VPCNR is unreachable, the second VPCNR may be used for sending 290. A digital sending service within the VPCNR may provide a computer network destination in addition to or in place of a user provided destination.

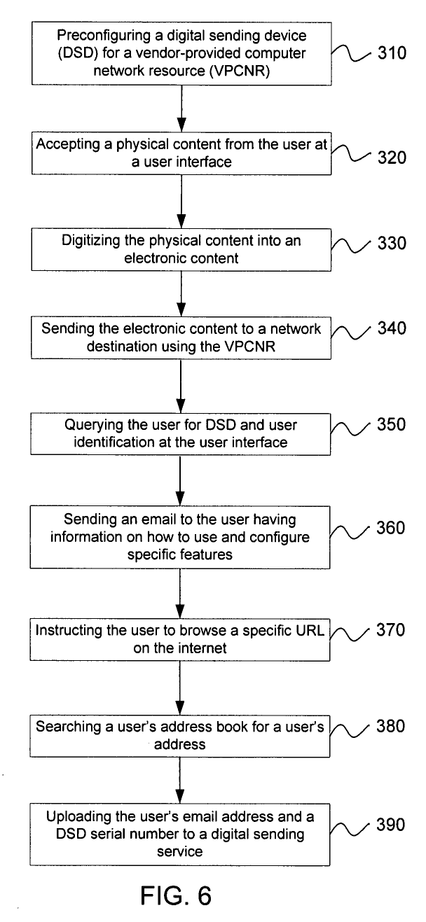

FIG. 6 is a flow chart of a method in accordance with an embodiment. Steps 310, 320, 330, and 340 are similar to steps 210, 220, 230, and 240 in FIG. 4. Additionally a step of querying 350 a user for DSD and user identification at the user interface is included. A step of sending 360 an email to the user is included with information on how to use and configure specific features. Furthermore steps for instructing 370 the user to browse a specific URL on the internet and searching 380 a user's address book for a user's address are also included. Uploading 390 the user's email address and a DSD serial number to a digital sending service is included in the embodied method flow chart. Not all of the preceding steps are required in all of the method embodiments.

Also secure email, and archival and retrieval of email, documents and facsimiles are comprehended in a method embodiment sending electronic content over the computer network infrastructure 10 using the digital sending service 22. Optical character recognition of a digitally sent document is also included in a method embodiment. Furthermore, establishing a persistent session link without an expiry between a user and a DSD is also included.

Optional services provided by the vendor may include message and content archival and retrieval, delivery receipt notification, digital signatures, users specific cover pages, job accounting by billing code and digital faxing. The preconfigured DSD may verify and validate that a computer network infrastructure is working properly to send electronic content from the DSD to a network destination. Also pre-installing a certificate on the device for use by the digital sending service in identifying a DSD is helpful for security purposes.

The managed system of an embodiment further may include a secured protocol which encrypts a user's message to a receiver through an algorithm and key. A secured protocol may further comprise user identification through a certificate, and a means for the receiver to encode a reply to the user by compressing data for example. Furthermore, a certificate of infrastructure may be included to secure the DSD to a digital sending service, and to identify a DSD subscribing to the computer network services.

The DSD may be preconfigured to be captive to certain VPCNR and certain computer network destinations on a network infrastructure in an embodiment. That is, the DSD may be preconfigured to deliver digital content only to a certain multifunction printer or facsimile machine through a certain email server. Also the DSD may be preconfigured to be captive to a certain digital sending service of a particular vendor.

A benefit of the present invention is that small and medium business users do not need to invest in and maintain email, directory services, and facsimile servers on a computer network. DSD may be shipped from the factory preconfigured for a minimum set of digital sending services. Since a preconfigured DSD may verify and validate a computer network infrastructure 10, troubleshooting does not require users familiar with a computer network 40. Additionally, new digital sending services may be provided without the need to change device firmware. Users may be informed of new products or enhanced features through a VPCNR.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A digital sending device (DSD) peripheral to a computer network, comprising:
a user interface to accept a physical content;
a digitizer coupled to the user interface to convert the physical content into an electronic content; and
a transmitter coupled to the user interface and to the digitizer preconfigured to deliver the electronic content through a vendor-provided computer network resource (VPCNR) to a computer network destination.

2. The DSD of claim 1 wherein the computer network destination is accepted at the user interface and communicated to the transmitter.

3. The DSD of claim 1 wherein the digitizer accepts keyboard input from a user as physical content to convert into an electronic content.

4. The DSD of claim 1 wherein a VPCNR is a digital sending service.

5. The DSD of claim 1 further comprising a token having an expiry after a predetermined number of transactions.

6. A method of digitally sending a physical content provided by a user to a computer network destination in a computer network infrastructure, comprising:
pre-configuring a digital sending device (DSD) for a vendor-provided computer network resource (VPCNR);
accepting a physical content from a user at a user interface;
digitizing the physical content into an electronic content; and
sending the electronic content to the computer network destination using the VPCNR.

7. The method of claim 6 further comprising sending the electronic content to a second VPCNR if the first VPCNR is unreachable.

8. The method of claim 6 wherein sending electronic content to a computer network destination further comprises sending the electronic content over secure channels using the VPCNR.

9. The method of claim 6 wherein the electronic content sent to a computer network destination is chosen from the group consisting of archiving and retrieving email, documents and facsimiles.

10. The method of claim 6 wherein digitizing physical content into electronic content further comprises electronically recognizing optical characters in the physical content.

11. The method of claim 6 further comprising establishing a persistent session link without an expiry between a user and the DSD.

12. The method of claim 6 further comprising:
querying the user for DSD and user identification at the user interface; and
sending an email to the user having information on how to use and configure specific digital sending service features.

13. The method of claim 6 further comprising:
instructing the user to browse a specific URL on the Internet;
searching a user's email address book for a user's address; and
uploading the user's email address and a DSD serial number to a digital sending service.

14. The method of claim 6 further comprising instructing the user to enter a user's email address.

15. The method of claim 6 further comprising sending to the computer network destination information on optional digital services offered by the vendor.

16. The method of claim 15 wherein the optional services are chosen from the group consisting of message and content archival and retrieval, delivery receipt notification, digital signatures, users specific cover pages, job accounting by billing code and digital faxing.

17. The method of claim 6 further comprising verifying and validating that the computer network infrastructure is operable for sending electronic content from a DSD to a computer network destination.

18. The method of claim 6 further comprising pre-installing a certificate on the DSD for use by a digital sending service in identifying the DSD.

19. A system of vendor-provided computer network resources (VPCNR) for delivering digital sending services between multiple electronic destinations and a plurality of digital sending devices (DSD), comprising:
a DSD coupled to a computer network having:
a user interface to accept a physical content;
a digitizer coupled to the user interface to convert the physical content into an electronic content;
a transmitter coupled to the user interface and to the digitizer
wherein the transmitter is preconfigured to use a VPCNR to deliver the electronic content to the multiple electronic destinations; and
a computer network infrastructure capable of delivering the digital sending services between the multiple electronic destinations and the plurality of DSD.

20. The system of claim 19 wherein an address of the multiple computer network destinations are accepted at the user interface and communicated to the transmitter.

21. The system of claim 19 further comprising a certificate of infrastructure used to secure the DSD to the VPCNR and to identify a DSD subscribing to a computer network service.

22. The system of claim 19 wherein the DSD is preconfigured to be captive to certain VPCNR and certain network destinations on a computer network.
